(19) United States
(12) Patent Application Publication
(10) Pub. No.: US 2011/0100564 A1
(43) Pub. Date: May 5, 2011

(54) Adjustment apparatus for venetian blinds

(76) Inventor: GREGORY SCOTT MCTAGGERT, ENCINITAS, CA (US)

(21) Appl. No.: 12/589,824

(22) Filed: Oct. 30, 2009

(51) Int. Cl. E06B 9/303

(52) U.S. Cl. 160/168.1 R

(57) ABSTRACT

An improvement to venetian blinds having a string ladder assembly for controlling the attitude of a first set of louvers. The improvement to the venetian blinds consisting of a means for selecting a subset of the first set of louvers wherein the means for selecting the subset comprises a second string ladder assembly which controls the attitude of the selected subset of louvers and additionally including means for selectively adjusting the attitude of the subset of louvers.

### BACKGROUND OF THE INVENTION

Blinds are coverings for a window or door, usually attached to the interior side of the window or door. Blinds hide from sight (thus “blinding” a viewer of the window) or to reduce sunlight. In other words, a window blind is a device the width of a window that can reduce light or hide the view seen through the window.

Window blinds are not a new concept; they have been around in one form or another since the Egyptians used reeds to fashion a type of blind. The Ming dynasty in ancient China even used roman shades as blinds. During the 1700's in Europe, modern blinds evolved from wooden shutters. The original versions of modern blinds (Venetian blinds) were made from 2″ strips of wood (louvers) suspended in the window opening by decorative ribbon. The window blinds can be grouped as shutter-like and shade-like and are an old technology. Drawings in ancient Egyptian tombs of reed blinds have been reported and a common window blind during the 1800's is said to have been the home-made roller shade. A blind covers from sight or sunlight. Window blinds have varying thermal effects: they can block unwanted heat of the summer sun, keep out moisture, and they can keep in heat in cold weather. But in each of these applications, they also reduce light to varying degrees, depending on the design. Many kinds of blinds attempt varying balances of privacy and shade.

Venetian blinds were introduced around 1770. Possibly in Venice, Italy but no one really knows for sure. The word Venetian may have just been a marketing gimmick of the Georgian Era. During the 1930s and '40s, window shades blinds were still being made from two inch wooden slats. There was a wave of popularity with blinds of the mini variety in the '80s. These were aluminum, baked-enamel painted, one-inch louvers, or slats. Louvers, generally, are an arrangement of parallel, horizontal blades, slats, laths, slips of glass, wood, or other material designed to regulate airflow or light penetration. They may be either movable or fixed. The name louver was originally applied to a turret or domelike lantern set on roofs of medieval European buildings for ventilation; the arrangement of boards now called a louver was one means of closing the apertures of this turret against weather. This original use of louvers is still current as covering for the intake and exhaust system of some ventilation and air-conditioning units. Throughout this application, the words louver and slat may be used interchangeably. The first new innovation for Venetian blinds came in 1946, when Hunter Douglas developed the first light weight aluminum louvers. These two-inch aluminum Venetian blind louvers became the standard for Venetian blinds.

However, there has not been a set of Venetian blinds in which a selected subset of louvers may be adjusted independent of the others. Such may be desirable to block the entry of sunlight at the top of the blinds while still permitting the passage of sunlight at the bottom of the blinds.

### SUMMARY OF THE INVENTION

The present invention pertains to an improvement to a set of venetian blinds, and more particularly, to a means for adjusting a selected subset of louvers of the venetian blinds by means of a additional ladder string that controls only the desired subset of louvers.

### DRAWINGS

FIG. 1 is a perspective view of a prior art set of blinds.

FIG. 2 is cut-away view of one end of the housing of the invention.

FIG. 3 is a top view of the housing of the invention.

FIG. 4 is a partial end view of the louvers of the invention.

FIG. 5 is a top view of a louver of the invention.

### DETAILED DESCRIPTION OF THE INVENTION

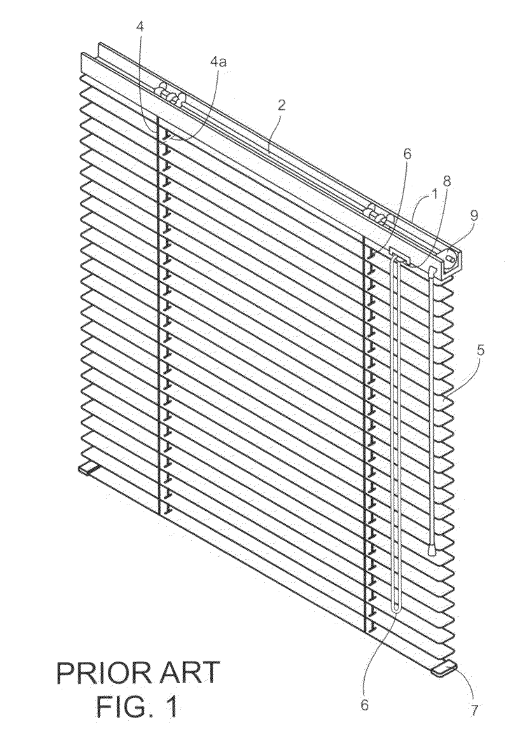

In present day venetian blinds, two sets of string assemblies typically control the actions of the louvers, the first, or primary, string ladder assembly for raising or lowering the blinds, and the second, or secondary, string ladder assembly for adjusting the attitude, or the angle, of the louvers. The strings for controlling the primary string assembly are typically disposed on the right side of the blind housing. In older sets of venetian blinds the strings for controlling the secondary string assembly are typically disposed on the distal left side of the blind housing. In more modern sets of venetian blinds, the strings for controlling the secondary string assembly has been replaced with a rod suspended from the blind housing and disposed adjacent from the string controlling the primary string assembly. The primary string ladder assembly is well known in the art, as shown in FIG. 1, wherein the blinds include an elongated housing 1, a plurality of louvers 5 suspended one above another from the housing 1, a bottom rail 7 disposed below the louvers 5, a plurality of pull strings 6, each of which has a first end that passes through the housing and through the louvers 5 and that is mounted to the bottom rail 7, and a second end that extends out of the housing 1, a clamping unit 8 provided at one end of the housing 1 for clamping releasably the pull strings 6, a plurality of pairs of tilting cords 4 disposed at longitudinal sides of each of the louvers 5 and having top ends secured to the shaft 2 and bottom ends secured to the bottom rail 7, a plurality of suspending strings 4a disposed below each of the louvers 5 to interconnect the tilting cords 4, and a tilt control unit 9 coupled to the shaft 2 for controlling tilting of the louvers 5, the tilt control unit including a vertical rod 9a suspended from tilt control unit 9, rotation of which vertical rod 9a causes tilting of the louvers 5.

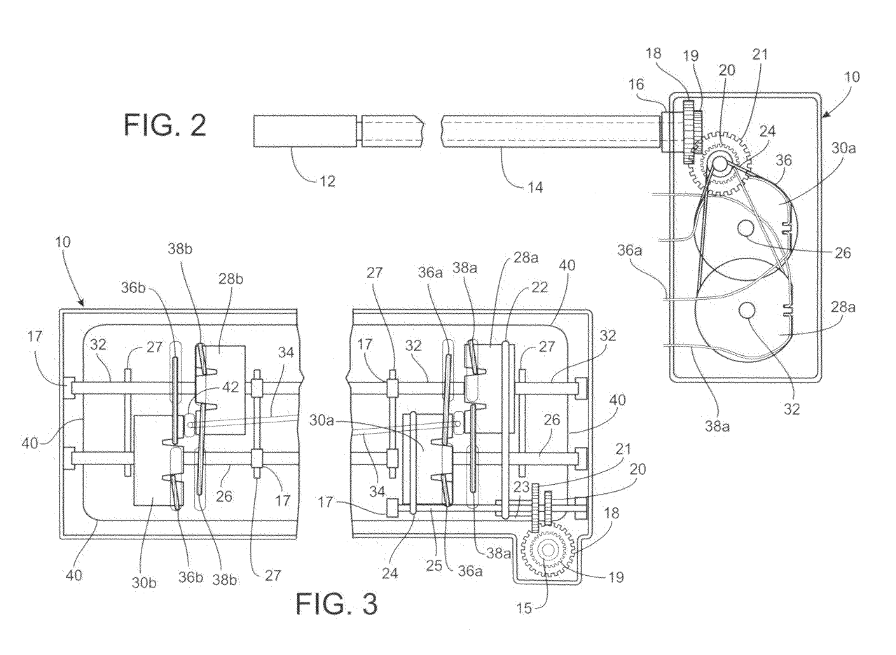

In the discussion of the present invention, only the string ladder assembly that controls the attitude/tilt/angle of the louvers will be discussed and will be referred to as the “first string ladder assembly.” The only disclosure of the string ladder assembly that raises and lowers the louvers is the depiction of the strings 23 (FIG. 2) that feed through slots 42a and 42b (FIG. 5).

The present invention is an improvement to Venetian blinds having a first string ladder assembly for adjusting the attitude of the louvers of the blinds. The improvement consists of an additional string ladder assembly that is deployed using an additional set of spools or pulleys to control the louvers. This additional string ladder assembly requires additional slots be placed in the blind housing (FIG. 5), adjacent the existing slots for the primary string ladder assembly. The additional string ladder assembly functions in the same manner as the first string ladder assembly, however the in this invention, both string ladder assemblies must be tied off to affect only a selected subset of the louvers on each ladder assembly.

Referring to FIGS. 2 and 3, lower handle 12 rotates about a vertical axis and extends in a reduced diameter to engage bushing 15, the reduced diameter providing a core for upper handle 14, which freely and independently rotates coaxially to lower handle 12. Lower handle 12 engages lower gear 19, which rotates about bushing 15. Lower gear 19 engages vertical gear 21 having cylindrical gear body 23 perpendicular to and coaxial with the horizontal axis of vertical gear 21. Gear body 23 rotationally drives lower belt 22, which is engaged about lower spool 28a, causing it to coaxially rotate about vertical rod 32. Rod 32 traverses housing 10 to engage and rotate lower spool 28b. Rod 32 is anchored at both ends by bushings 17, and is intermediately supported by additional bushings 17, which are in turn supported by brackets 27.

Upper handle 14 engages upper gear 18, which rotates about bushing 15. Upper gear 18 engages vertical gear 20 which causes rod 25 to rotate coaxial with the horizontal axis of vertical gear 20. Rod 25 rotationally drives upper belt 24, which is engaged about upper spool 30a, causing it to coaxially rotate about vertical rod 26. Rod 26 traverses housing 10 to engage and rotate upper spool 30b. Rod 26 is anchored at both ends by bushings 17, and is intermediately supported by additional bushings 17, which are in turn supported by brackets 27. Gears 18, 19, 20 and 21 have been depicted as flat gears, but one of ordinary skill in the art would recognize that worm, miter, or bevel gears may be interchangeably used. Since lower handle 12 and upper handle 14 will be rotated by hand, the only criteria for the selected gears are that they easily and smoothly mesh.

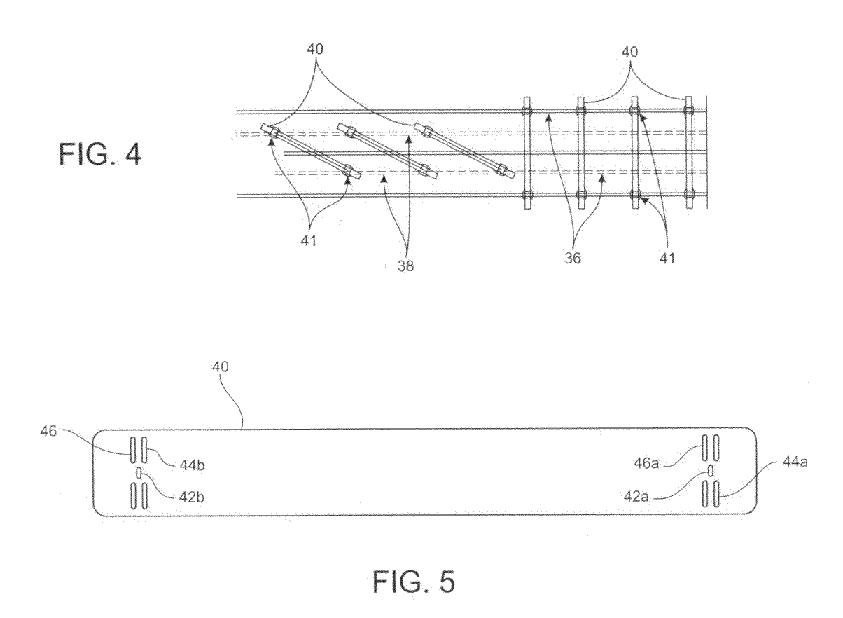

Referring again to FIGS. 1 and 2, lower spools 28a and 28b control lower ladder strings 38a and 38b, which are affixed to an suspended from their respective spools to control a selected subset of contiguous louvers 40 (FIG. 4). Ladder strings 38a and 38b are disposed such that one set of strings is suspended at the leading edge of each selected louver 40, and one set of strings is disposed at the trailing edge of each louver 40. The ladder strings are then affixed to each louver 40 by means of a pair of clips 41, thereby attaching each selected louver 40 to the ladder strings 38a and 38b. Concomitantly, upper spools 30a and 30b control upper ladder strings 36a and 36b, which are affixed to an suspended from their respective spools to control a selected subset of contiguous louvers 40 (FIG. 4). Ladder strings 36a and 36b are also disposed such that one set of strings is suspended at the leading edge of each selected louver 40, and one set of strings is disposed at the trailing edge of louver 40. The ladder strings are then affixed to each louver 40 by means of a pair of clips 41, thereby attaching each selected louver 40 to the ladder strings 36a and 36b. Therefore, when lower handle is rotated in a selected direction, the attitude of the selected louvers is thereby changed, and when the upper handle is rotated in a selected direction, the attitude of the selected louvers is thereby changed. It should be noted that any type of clip 40 may be utilized. One of ordinary skill in the art may select from an number of clips that may accomplish the task.

It should be obvious to one of ordinary skill in the art that the above description is only one means to accomplish the invention. For example, strings suspended from gears 20 and 21 could be used to control spools 28a and 30a to achieve the same purpose. And spools 28b and 30b could be controlled by means of strings and pulleys within the spirit and claims of the invention. Accordingly, the scope of the invention should not be determined by the specific embodiments illustrated herein. The full scope of the invention is further illustrated by the claims appended hereto.

I claim:

1. An improvement to venetian blinds having a first string ladder assembly for controlling the attitude of a first set of louvers, the improvement comprising:
means for selecting a subset of louvers; and
means for independently adjusting the attitude of the subset of louvers.

2. The improvement of claim 1 wherein the means for selecting the subset of louvers comprises a second string ladder assembly which controls the attitude of the subset of louvers.

3. The improvement of claim 1 wherein the venetian blinds includes primary handle means for adjusting the first set of louvers and the means for selectively adjusting the attitude of the subset of louvers comprises secondary handle means.

4. The improvement of claim 3 wherein the secondary handle means is coaxial to the primary handle means.

5. The improvement of claim 3 wherein the primary handle means and the secondary handle means include respectively a first gear means for adjusting first string ladder assembly and a second gear means for adjusting the second string ladder assembly.

6. The improvement of claim 5 wherein the first gear means includes a first primary gear and a first secondary gear, the first primary gear coupled to the primary handle, the first secondary gear perpendicular to and enmeshing with the first primary gear; wherein second gear means includes a second primary gear and a second secondary gear, the second primary gear coupled to the secondary handle, the second secondary gear perpendicular to and enmeshing with the second primary gear; and wherein the first secondary gear and the second secondary gear respectively are affixed to primary and secondary rotating rods, the primary and secondary rods for adjusting respectively the first ladder assembly and the second ladder assembly.

7. The improvement of claim 1 wherein the primary and secondary rotating rods are coupled respectively to a first spool means and a second spool means.

8. The improvement of claim 7 wherein the primary spool means controls the first string ladder assembly, which includes attachment means for attaching the first string assembly to louvers complementary to the selected subset of louvers.

9. The improvement of claim 7 wherein the secondary spool means controls the second string ladder assembly, which includes attachment means for attaching the second string assembly to the selected subset of louvers.

10. An improvement to venetian blinds having a first string ladder assembly for controlling the attitude of a first set of louvers, the improvement comprising:
means for selecting a subset of the first set of louvers wherein the means for selecting the subset comprises a second string ladder assembly which controls the attitude of the selected subset of louvers; and
means for selectively adjusting the attitude of the subset of louvers.

11. The improvement of claim 10 wherein the venetian blinds includes primary handle means for adjusting the first string ladder assembly and the means for selectively adjusting the attitude of the subset of louvers comprises secondary handle means.

12. The improvement of claim 11 wherein the secondary handle means is coaxial to the primary handle means.

13. The improvement of claim 11 wherein the primary handle means and the secondary handle means include respectively a first gear means for adjusting first string ladder assembly and a second gear means for adjusting the second string ladder assembly.

14. The improvement of claim 13 wherein the first gear means includes a first primary gear and a first secondary gear, the first primary gear coupled to the primary handle, the first secondary gear perpendicular to and enmeshing with the first primary gear; wherein second gear means includes a second primary gear and a second secondary gear, the second primary gear coupled to the secondary handle, the second secondary gear perpendicular to and enmeshing with the second primary gear; wherein the first secondary gear and the second secondary gear respectively are coupled to primary and secondary rotating rods; the primary and secondary rods for adjusting respectively the first string ladder assembly and the second string ladder assembly.

15. The improvement of claim 14 wherein the primary and secondary rotating rods are coupled respectively to a first spool means and a second spool means.

16. The improvement of claim 15 wherein the primary spool means controls the first string ladder assembly, which includes attachment means for attaching the first string assembly to louvers complementary to the selected subset of louvers.

17. The improvement of claim 15 wherein the secondary spool means controls the second string ladder assembly, which includes attachment means for attaching the second string assembly to the selected second subset of louvers.
